(19) United States
(12) Patent Application Publication
(10) Pub. No.: US 2025/0197974 A1
(43) Pub. Date: Jun. 19, 2025

(54) Aluminum Alloy For Die Casting Having Excellent Thermally Conductive Property And Method For Producing Die Casting Material Using The Same

(71) Applicant: AISIN KEIKINZOKU CO., LTD., Imizu-shi (JP)

(72) Inventors: Yasuo OKAMOTO, Imizu-shi (JP); Mai FUTAZUKA, Imizu-shi (JP); Hiroaki MATSUI, Imizu-shi (JP); Takanari YOSHIMURA, Imizu-shi (JP); Tomoo YOSHIDA, Imizu-shi (JP)

(21) Appl. No.: 19/071,911

(22) Filed: Mar. 6, 2025

Related U.S. Application Data
(63) Continuation of application No. PCT/JP2023/033086, filed on Sep. 11, 2023.

(30) Foreign Application Priority Data
Sep. 16, 2022 (JP) 2022-147731

(51) Int. Cl. C22C 21/00; B22D 17/20

(52) U.S. Cl. CPC C22C 21/00; B22D 17/20

(57) ABSTRACT

An aluminum alloy for die casting g that has excellent thermally conductive properties contains, by mass, 0.4 to less than 1.4% of Fe, 0.1 to 0.8% of Si, and 0.1 to 1.0% of Mg, with the balance being Al and unavoidable impurities.

### CROSS REFERENCE TO RELATED APPLICATIONS

This application is a continuation of International Patent Application No. PCT/JP2023/033086, having an international filing date of Sep. 11, 2023, which designated the United States, the entirety of which is incorporated herein by reference. Japanese Patent Application No. 2022-147731 filed on Sep. 16, 2022 is also incorporated herein by reference in its entirety.

### BACKGROUND OF THE INVENTION

The present disclosure relates to an aluminum alloy having excellent thermally conductive properties that is suitable for a housing case, a heat sink for heat radiation, or the like of an electronic component used in, for example, a vehicle or an electronic device, the aluminum alloy in which a recycled material can be used as a feedstock, and particularly to a die casting material using the aluminum alloy and a method for producing the die casting material.

In recent years, the automotive industry has been experiencing structural change called “CASE”, an acronym for Connected, Autonomous (Automated), Shared, and Electric.

As a part of the change, the performance of electronic devices has been improved, and accordingly, the amount of heat generated by the electronic devices tends to increase. Therefore, improved cooling performance is required.

As one of the countermeasures, the use of an aluminum material as a material for a housing, a heat sink, or the like of an electronic device is being considered.

For example, JP-B-4328927 discloses an aluminum alloy material containing, by mass, 0.0002 to 0.08% of B, 0.05 to 2.5% of Fe, and 0.05% to 2.5% of Ni, where the percentage of B is 0.4 to 6.5% of the amount of Fe and Ni, with the balance being Al and unavoidable impurities.

Although improved in strength through the addition of Fe and Ni and in thermally conductive properties through the addition of B, the aluminum alloy material inevitably has poorer thermally conductive properties than pure aluminum material.

JP-B-5387342 discloses a heat sink formed by die casting, the heat sink containing 4 to 13% of Si, 0.22 to 2.0% of Mg, 0.2 to 1.0% of Fe, and 0.5 to 5.0% of Cu or Ni, with the balance being Al.

However, such an aluminum alloy still has insufficient thermally conductive properties.

JP-B-5301750 discloses an aluminum alloy for die casting containing 2.30% or less of Cu, 1.50% or less of Si, and 1.20 to 2.60% of Fe, with the balance being Al and unavoidable impurities.

Although the alloy is strong, the thermally conductive properties and die casting castability are insufficient.

JP-A-56-166359 discloses a tough aluminum alloy for die casting containing 1.4 to 2.5% of Fe, 0.5 to 1.2% of Si, and 0.2 to 1.2% of Mg, with the balance being aluminum and impurities.

However, this publication aims to obtain toughness and makes no mention of enhancement of thermally conductive properties.

JP-A-2002-226932 discloses an aluminum alloy material for a heat sink, the aluminum alloy material containing 0.40 to 1.60 wt % of Si, 0.30 to 0.70 wt % of Mg, 0.20 to 1.00 wt % of Fe, and 0.002 to 0.08 wt % of B, with the balance being aluminum and unavoidable impurities, and having an electrical conductivity of 48% IACS or more and a Brinell hardness value of 50 or more.

Pure aluminum is known to be good in terms of thermally conductive properties, but due to its inferior die casting castability and lower strength, an Al-Fe based alloy has been studied.

However, a conventional Al—Fe-based alloy for die casting has relatively high purity, making it difficult to use a recycled material as a raw material, which in turn contributes to higher costs.

Furthermore, when the Al—Fe based alloy is applied as an assembled structural member, strength as well as thermally conductive properties are required.

In addition, when used for a housing, a heat sink, or the like of an electronic device, which requires electromagnetic sealing, grounding, and corrosion resistance, the alloy must be excellent, as the material, in electrically conductive properties and corrosion resistance.

Both JP-A-56-166359 and JP-A-2002-226932 make no mention of an aluminum alloy material in which recycled material can be used as a feedstock.

### BRIEF DESCRIPTION OF THE DRAWINGS

FIG. 1 illustrates the alloy composition and evaluation results of a die cast product without heat treatment.

FIG. 2 illustrates the alloy composition and evaluation results of a die cast product after heat treatment.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

An object of the present disclosure is to provide an aluminum alloy for die casting that has excellent thermally conductive properties and is also suitable for die casting, as well as an aluminum alloy for die casting that has excellent electrically conductive properties, corrosion resistance, and strength in which a recycled material can be used as a feedstock.

Another object of the present disclosure is to provide a method for producing a die casting material in which a recycled material can also be used as a feedstock.

In accordance with one of some embodiments, an aluminum alloy for die casting having excellent thermally conductive properties contains, by mass, 0.4 to less than 1.40% of Fe, 0.1 to 0.8% of Si, and 0.1 to 1.0% of Mg, with the balance being Al and unavoidable impurities.

In accordance with one of some embodiments, when the balance between thermally conductive properties and strength is taken into consideration, the aluminum alloy for die casting may be selected to contain, by mass, 0.4 to less than 1.4% of Fe, 0.4 to 1.2% of Si, 0.1 to 0.9% of Mg, and the balance being Al and unavoidable impurities. The reasons for selecting the components are as follows.

Hereinafter, all are expressed in % by mass.

### Fe

The Fe content is 0.4% to less than 1.4%, preferably in the range of 0.4% to 1.3%.

If the content is less than 0.4%, castability during die casting decreases, and if it is more than 2.0%, thermally conductive properties are deteriorated.

Further, a Fe content of more than 2.0% may also cause a decrease in electrically conductive properties and corrosion resistance.

If the Fe content is 0.4 to less than 1.4%, excellent thermally conductive properties, electrically conductive properties and corrosion resistance can be obtained while the castability can be maintained.

### Si

The Si content is in the range of 0.1 to 0.8%, preferably 0.2 to 0.6%. The Si content can also be in the range of 0.1 to 1.2% or 0.4 to 1.2%.

A Si content of less than 0.1% causes a decrease in castability and strength in die casting.

In this regard, Si is preferably contained in an amount of 0.4% or more to improve the strength and in an amount of 1.2% or less to suppress deterioration of the thermally conductive properties.

### Mg

The Mg content is in the range of 0.1 to 1.0%, preferably 0.1 to 0.9%.

More preferably, it is in the range of 0.2 to 0.7%.

If the content is less than 0.1%, the strength decreases. If it is more than 1.0%, the thermally conductive properties are deteriorated.

### Ti, B, or Zn

When a recycled material is used as a feedstock for the aluminum alloy for die casting according to the present disclosure, the inclusion of unavoidable impurities such as Ti, B, or Zn associated with the recycled material is allowed within a range that does not bring about decreased strength, poor castability, deteriorated thermally conductive properties, deteriorated electrically conductive properties, or decreased corrosion resistance.

That is, when a recycled material is used as a feedstock, the aluminum alloy for die casting according to the present disclosure may contain, by mass, at least one of 0.005 to 0.3% of Ti, 0.0001 to 0.06% of B, and 0.001 to 0.7% of Zn. In this case, the inclusion of B may be excluded.

### Zn

The Zn content is 0.001 to 0.7%, preferably 0.5% or less. If the Zn content is more than 0.7%, corrosion resistance decreases.

### Ti

The Ti content is in the range of 0.005 to 0.3%, preferably 0.02 to 0.2%.

If the content is less than 0.005%, the effect of grain refinement is low, and the effects of improving the strength and suppressing casting cracks are low.

If the content is more than 0.3%, the thermally conductive properties are deteriorated.

### B

The B content is in the range of 0.0001 to 0.06%, preferably 0.0005 to 0.04%.

If the content is less than 0.0001%, the effect of grain refinement is low, and the effects of improving the strength and suppressing casting cracks are low.

If it is more than 0.06%, the amount of hard phase that reduce tool life becomes large.

### Other Components

In the present disclosure, components other than Fe, Si, Mg, Ti, B, and Zn are treated as unavoidable impurities, whether or not recycled materials are used as a feedstock for the aluminum alloy for die casting, and the incorporation of unavoidable impurities is allowed within a range that does not bring about decreased strength, poor castability, deteriorated thermally conductive properties, deteriorated electrically conductive properties, or decreased corrosion resistance.

In accordance with one of some embodiments, an aluminum alloy for die casting having excellent thermally conductive properties contains, by mass, 1.81 to 2.0% of Fe, 0.1 to 0.8% of Si, 0.1 to 1.0% of Mg, and at least one of 0.005 to 0.3% of Ti, 0.0001 to 0.06% of B, and 0.001 to 0.7% of Zn, with the balance being Al and unavoidable impurities.

In accordance with one of some embodiments, an aluminum alloy for die casting having excellent thermally conductive properties contains, by mass, 1.81 to 2.0% of Fe, 0.1 to 1.2% of Si, 0.1 to 0.9% of Mg, and at least one of 0.005 to 0.3% of Ti, 0.0001 to 0.06% of B, and 0.001 to 0.7% of Zn, with the balance being Al and unavoidable impurities.

### Fe

If the Fe content is 1.81 to 2.0%, aside from the above-mentioned range of 0.4 to less than 1.4%, excellent thermally conductive properties can also be obtained.

In the present disclosure, die casting may be performed using the above-described aluminum alloy for die casting, followed by annealing through natural cooling in the air after maintaining a temperature of 300 to 410° C. for 1 to 6 hours.

Note that furnace cooling may be performed by turning off the heater of the furnace while holding the aluminum alloy in the heating furnace, which is also natural cooling in the air.

When die casting is performed using the aluminum alloy for die casting according to the present disclosure, the aluminum alloy has a thermal conductivity of 170 W/m·K or more without heat treatment, but the thermal conductivity reaches 185 W/m·K or more after heat treatment in this manner.

Here, when the heat treatment temperature exceeds 410° C., blisters may occur in a die cast material.

In the present disclosure, a step (T5 treatment) may be taken in which die casting is performed using the aluminum alloy for die casting, followed by natural cooling in the air after maintaining a temperature of 160 to 210° C. for 1 to 6 hours.

The heat treatment performed in this manner results in a 0.2% proof stress of 80 MPa or more while the thermal conductivity is kept at 170 W/m·K or more.

Note that when the heat treatment temperature is less than 160° C., the improvement in strength and thermally conductive properties is small.

In the case of using the aluminum alloy for die casting according to the present disclosure, a recycled material can also be used as a feedstock, and a die casting material having high strength and high thermal conductivity that is excellent in die casting castability can be obtained. Therefore, the aluminum alloy can be widely applied to a housing configured to accommodate an electronic component and a heat sink material.

The use of recycled materials can also suppress the decrease in electrically conductive properties and corrosion resistance.

Exemplary embodiments are described below. Note that the following exemplary embodiments do not in any way limit the scope of the content defined by the claims laid out herein. Note also that all of the elements described in the present embodiment should not necessarily be taken as essential elements.

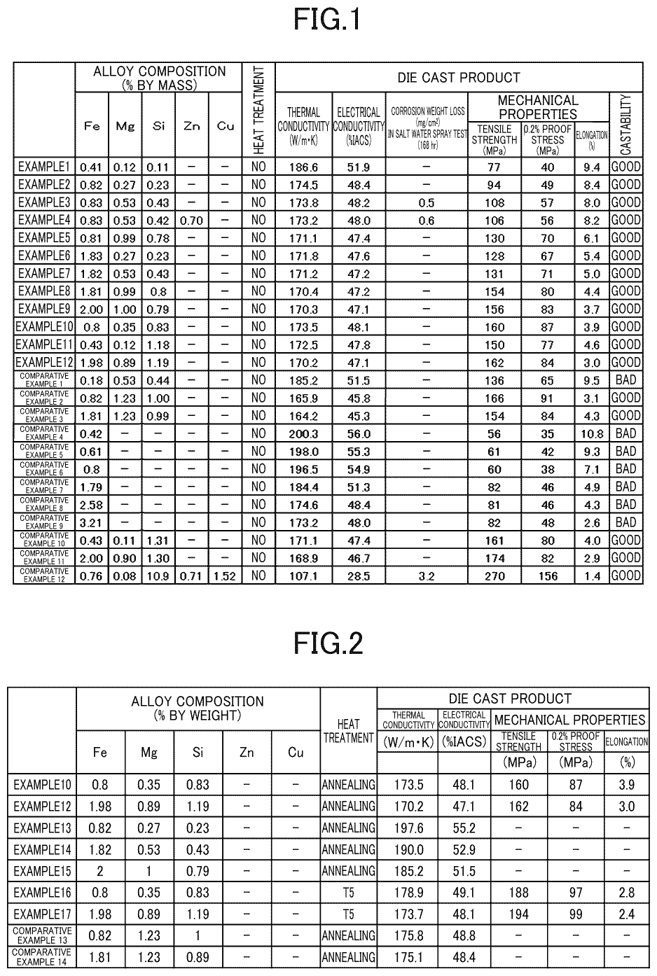

In Examples and Comparative Examples, a feedstock containing aluminum and alloying elements was melted, and a die cast product was prepared by die casting using a molten metal of an aluminum alloy having the chemical components shown in FIG. 1 and then evaluated.

The thermal conductivity, electrical conductivity, and mechanical properties of Examples and Comparative Examples were measured in an as cast state without heat treatment, and corrosion resistance was evaluated by a salt water spray test.

The results are shown in FIG. 1.

Examples and Comparative Examples were also subjected to die casting at an injection speed of 2.2 m/sec and a casting pressure of 60 MPa, and castability was confirmed by appearance and presence of internal defects.

“GOOD” indicates no problems in castability, while “BAD” indicates some problems in castability.

The results of castability are also shown in FIG. 1.

Casting materials using the aluminum alloys of Examples each have a thermal conductivity of 170 W/m·K or more, which is suitable for a heat radiating member, without any problem in the castability of die casting.

Here, the thermal conductivity (W/m·K) was calculated as follows: thermal conductivity=thermal diffusivity×specific heat×density.

The thermal diffusivity was measured using LFA 467 manufactured by NETZSCH at a measurement temperature of 60° C. after cutting out a sample from a die cast product.

The specific heat was measured using DSC 500 manufactured by NETZSCH at a measurement temperature of 60° C.

The bulk density at room temperature, in which the dimensions of the sample were obtained from its mass, was used as the density.

The electrical conductivity was measured using an eddy current electrical conductivity meter at a measurement temperature of 24° C. after cutting out a sample from a die cast product.

The salt water spray test was conducted for 168 hours in accordance with JIS by cutting out a sample from a die cast product, and the weight loss due to corrosion was calculated from the weight measurements of the sample before and after the test.

The mechanical properties were measured using a tensile tester in accordance with JIS by cutting out a sample from a die cast product.

Examples 1 to 9 contained Fe in the range of 0.4 to 2.0%, Si in the range of 0.1 to 0.8%, and Mg in the range of 0.1 to 1.0%, had a thermal conductivity of 170 W/m·K or more, which were obtained only by casting without heat treatment, and had excellent castability.

Although the Si content in Examples 10 to 12 was 0.8% or more, the content was limited to 1.2% or less while Mg was selected in the range of 0.1 to 0.9%. Thus, the thermal conductivity slightly decreased, but the strength was relatively improved while the target of 170 W/m·K or more was achieved.

It was also confirmed that the castability was excellent.

In addition, these examples had an electrical conductivity of 45% IACS or more and a corrosion weight loss of 1 mg/cm² or less.

On the other hand, Comparative Example 1 was inferior in castability because the Fe content was 0.18 and less than 0.4%.

Comparative Examples 2 and 3 were able to maintain castability, but the thermal conductivity did not reach the target due to a large amount of Mg.

Since the Ze content was as high as 0.71% in addition to a large amount of Cu, Comparative Example 12 had poor electrically conductive properties and corrosion resistance even though castability was ensured with Si.

Comparative Examples 10 and 11 were able to ensure castability, but the thermal conductivity did not reach the target due to a high content of Si.

Comparative Examples 4 to 9 had poor castability.

A feedstock containing aluminum and alloying elements was melted, then die casting was performed using an aluminum alloy having the chemical components shown in FIG. 2.

Using those die cast products, Examples 13 to 15 and Comparative Examples 13 and 14 were annealed by maintaining a temperature of 350° C. for 3 hours and then allowing them to cool in the air.

Examples 16 and 17 were subjected to a heat treatment of the T5 treatment at 190° C. for 3 hours.

The thermal conductivity, electrical conductivity, and mechanical properties of these materials were measured in the same manner as above, and the results are shown in FIG. 2.

In FIG. 2, Example 13, unlike Example 2 which was not subjected to heat treatment, was annealed by cooling in the air after being held at 350° C. for 3 hours. Similarly, Example 14 was a sample in which heat treatment was performed against Example 7, and Example 15 was a sample in which heat treatment was performed against Example 9.

In either case, the thermal conductivity was increased to 185 W/m·K or more.

Comparative Examples 13 and 14 were samples in which heat treatment were performed against Comparative Examples 2 and 3 in the same manner above but had a lower improvement rate of thermal conductivity than Examples 13 to 15.

Examples 16 and 17 are examples in which the materials of Examples 10 and 12 were subjected to T5 treatment at 190° C. for 3 hours.

Compared with Examples 13 to 15, Examples 16 and 17 ensured a tensile strength of 130 MPa or more and a proof stress of 90 MPa or more, although the improvement rate of the thermal conductivity were lower.

Note that the same results can be obtained even if Examples 1 to 5, 10, 11, 13, and 16 further contain, as the alloy composition, at least one of 0.005 to 0.3% of Ti and 0.001 to 0.7% of Zn.

The same results can also be obtained even if Examples 6 to 9, 12, 14, 15, and 17 further contain, as the alloy composition, at least one of 0.005 to 0.3% of Ti, 0.0001 to 0.06% of B, and 0.001 to 0.7% of Zn.

Upon observation of the microstructure of the die casting material according to the present disclosure, it was found to have a eutectic structure of Al and Fe, with uniformly dispersed spherical primary crystals α and an Al—Fe based crystallized product in a gap between the primary crystals α. Therefore, it is presumed that the continuity of the primary crystals α in the Al—Fe based crystallized product improved thermally conductive properties.

### INDUSTRIAL APPLICABILITY

The aluminum alloy for die casting according to the present disclosure has excellent thermally conductive properties. When combined with a heat treatment, the aluminum alloy can be further improved in thermal conductivity and strength. Within this component range, recycled materials can also be used as raw materials.

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

1. An aluminum alloy for die casting that has excellent thermally conductive properties, comprising, by mass: 0.4 to less than 1.4% of Fe, 0.1 to 0.8% of Si, and 0.1 to 1.0% of Mg, with a balance being Al and unavoidable impurities.

2. The aluminum alloy for die casting according to claim 1, further comprising, by mass, at least one of 0.005 to 0.3% of Ti and 0.001 to 0.7% of Zn.

3. An aluminum alloy for die casting that has excellent thermally conductive properties and strength, comprising, by mass: 0.4 to less than 1.4% of Fe, 0.4 to 1.2% of Si, and 0.1 to 0.9% of Mg, with a balance being Al and unavoidable impurities.

4. The aluminum alloy for die casting according to claim 3, further comprising, by mass, at least one of 0.005 to 0.3% of Ti and 0.001 to 0.7% of Zn.

5. An aluminum alloy for die casting that has excellent thermally conductive properties, comprising, by mass: 1.81 to 2.0% of Fe, 0.1 to 0.8% of Si, 0.1 to 1.0% of Mg, and at least one of 0.005 to 0.3% of Ti, 0.0001 to 0.06% of B, and 0.001 to 0.7% of Zn, with a balance being Al and unavoidable impurities.

6. An aluminum alloy for die casting that has excellent thermally conductive properties and strength, comprising, by mass: 1.81 to 2.0% of Fe, 0.4 to 1.2% of Si, 0.1 to 0.9% of Mg, and at least one of 0.005 to 0.3% of Ti, 0.0001 to 0.06% of B, and 0.001 to 0.7% of Zn, with a balance being Al and unavoidable impurities.

7. A method for producing a die casting material, comprising performing die casting using the aluminum alloy for die casting according to claim 1.

8. The method for producing a die casting material according to claim 7, comprising maintaining a temperature of 160 to 210° C. for 1 to 6 hours after the die casting, followed by natural cooling in air.

9. The method for producing a die casting material according to claim 7, comprising maintaining a temperature of 300 to 410° C. for 1 to 6 hours after the die casting, followed by natural cooling in air.

10. The method for producing a die casting material according to claim 7, wherein the aluminum alloy for die casting is made from a recycled material as a raw material.

11. A method for producing a die casting material, comprising performing die casting using the aluminum alloy for die casting according to claim 3.

12. The method for producing a die casting material according to claim 11, comprising maintaining a temperature of 160 to 210° C. for 1 to 6 hours after the die casting, followed by natural cooling in air.

13. The method for producing a die casting material according to claim 11, comprising maintaining a temperature of 300 to 410° C. for 1 to 6 hours after the die casting, followed by natural cooling in air.

14. The method for producing a die casting material according to claim 11, wherein the aluminum alloy for die casting is made from a recycled material as a raw material.

15. A method for producing a die casting material, comprising performing die casting using the aluminum alloy for die casting according to claim 5.

16. The method for producing a die casting material according to claim 15, comprising maintaining a temperature of 160 to 210° C. for 1 to 6 hours after the die casting, followed by natural cooling in air.

17. The method for producing a die casting material according to claim 15, comprising maintaining a temperature of 300 to 410° C. for 1 to 6 hours after the die casting, followed by natural cooling in air.

18. The method for producing a die casting material according to claim 15, wherein the aluminum alloy for die casting is made from a recycled material as a raw material.

19. A method for producing a die casting material, comprising performing die casting using the aluminum alloy for die casting according to claim 6.

20. The method for producing a die casting material according to claim 19, comprising maintaining a temperature of 160 to 210° C. for 1 to 6 hours after the die casting, followed by natural cooling in air.

21. The method for producing a die casting material according to claim 19, comprising maintaining a temperature of 300 to 410° C. for 1 to 6 hours after the die casting, followed by natural cooling in air.

22. The method for producing a die casting material according to claim 19, wherein the aluminum alloy for die casting is made from a recycled material as a raw material.
